(19) United States
(12) Patent Application Publication
(10) Pub. No.: US 2025/0104941 A1
(43) Pub. Date: Mar. 27, 2025

(54) ELECTRONIC DEVICES WITH TACTILE KEYBOARDS AND RELATED METHODS

(71) Applicant: Intel Corporation, Santa Clara, CA (US)

(72) Inventors: Yew San Lim, Gelugor (MY); Ming-Sheng Tsai, Taipei (TW); Chung Jen Ho, New Taipei City (TW); Chi Chou Cheng, Taipei City (TW); Min Suet Lim, Gelugor (MY); Hari Raghavan Jayaraj, Bengaluru (IN)

(21) Appl. No.: 18/474,873

(22) Filed: Sep. 26, 2023

(51) Int. Cl. H01H 13/807; G06F 1/16; H01H 13/85; H01H 13/86; H01H 13/88

(52) U.S. Cl. CPC H01H 13/807; G06F 1/1662; H01H 13/86; H01H 13/88; H01H 13/85

(57) ABSTRACT

Systems, apparatus, articles of manufacture, and methods are disclosed for electronic devices with tactile keyboards. An example electronic device includes a tactile keyboard having a plurality of rows of keys; a printed circuit board; a first row of switches on the printed circuit board, a first row of the plurality of rows of keys to interact with the first row of switches; and a second row of switches on a component adjacent to the printed circuit board, a second row of the plurality of rows of keys to interact with the second row of switches.

### FIELD OF THE DISCLOSURE

This disclosure relates generally to electronic devices and, more particularly, to electronic devices with tactile keyboards and related methods.

### BACKGROUND

Electronic devices that include tactile keyboard may have a greater thickness than electronic devices with touch screen keyboards.

### BRIEF DESCRIPTION OF THE DRAWINGS

FIG. 1 illustrates a top view of a portion of an electronic device with a tactile keyboard of the prior art.

FIG. 2 illustrates an inside view of an example cover of an example electronic device with a partially assembled example tactile keyboard.

FIG. 3 illustrates an exploded view of an example key for the tactile keyboard of FIG. 2.

FIG. 4 illustrates assembly of the key of FIG. 3 into the cover of FIG. 2.

FIG. 5 illustrates the cover of FIG. 2 with an example top row of keys for the tactile keyboard.

FIG. 6 illustrates a top view of an example printed circuit board.

FIG. 7 illustrates a bottom view of the printed circuit board of FIG. 6.

FIG. 8 is an enlarged cross-sectional view of an example key and switch connection.

FIG. 9 illustrates the cover of FIG. 2 with the printed circuit board of FIG. 6 coupled thereto.

FIG. 10 is an enlarged top perspective view of a partial cross-sectional of the keyboard of FIG. 2 and the printed circuit board of FIG. 6.

FIG. 11 is an enlarged bottom perspective view of a partial cross-sectional of the keyboard of FIG. 2 and the printed circuit board of FIG. 6.

FIG. 12 is a cross-sectional view of a portion of a first end the electronic device incorporating the cover and keyboard of FIG. 2 and the printed circuit board of FIG. 6.

FIG. 13 is a cross-sectional view of a portion of a second end the electronic device incorporating the cover and keyboard of FIG. 2.

FIG. 14 illustrates a top view of a portion of the electronic device incorporating the cover and keyboard of FIG. 2.

FIG. 15 is a flowchart representing instructions to assemble an electronic device in accordance with the teaching of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

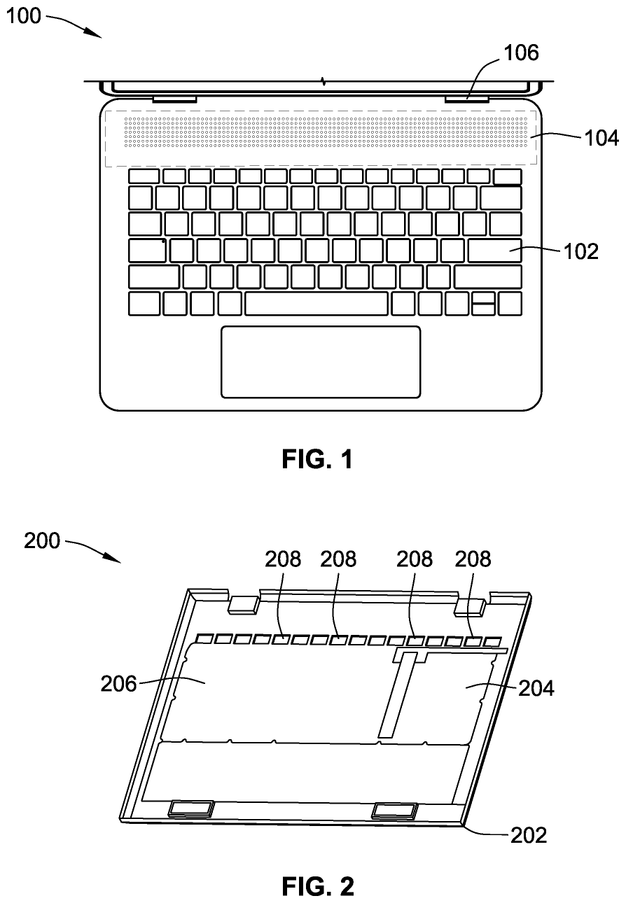

Electronic devices such as, for example, portable computers or laptop computers, include a tactile keyboard, which also may be referred to a mechanical keyboard or physical keyboard. In some electronic devices, the tactile keyboard overlaps with the printed circuit board (e.g., the mainboard), which increases the thickness or z-height of the electronic device. For example, some electronic devices with a tactile keyboard positioned over a printed circuit board have a z-height greater than 10 millimeters (mm). In other electronic devices, the tactile keyboard and the printed circuit board may not overlap. FIG. 1 shows a portion of an example electronic device 100 that includes a tactile keyboard 102 and a printed circuit board (within the electronic device 100) that do not overlap. This arrangement leads to an extended area 104 in the y-dimension. The extended area 104 between the keyboard 102 and an edge 106 of the device (e.g., the edge that includes a hinge to couple to a display panel) is known as the forehead. In the example electronic device 100 of FIG. 1, the forehead 104 is about 48 mm in the y-dimension. Thus, conventional electronic devices that include tactile keyboards have a trade-off between the thickness of the electronic device and the size of the forehead. Other devices include touch sensor keys to reduce the thickness of the device and/or the size of the forehead. However, user experience is more satisfying with electronic devices with tactile keys.

Examples disclosed herein include electronic devices that have tactile keyboards that partially overlap with printed circuit boards. The partial overlap between the tactile keyboard and the printed circuit board enable the electronic device to be thinner (smaller z-height) and have a smaller or narrower forehead compared to devices with touch sensor keyboard and/or devices with keyboard that do not overlap the printed circuit board.

Example electronic devices disclosed herein include a first or top row keys of a tactile keyboard overlapping with a printed circuit board (e.g., the mainboard). In some examples disclosed herein, a thickness of the electronic device can be reduced by approximately 33%. In some examples disclosed herein, a forehead of the electronic device can be reduced to a width of less than 40 mm. In addition, in examples disclosed herein, touch sensor keys are avoided and tactility is preserved for enhanced user experience.

FIG. 2 illustrates a portion of an example electronic device 200. For example, FIG. 2 shows an inside view of an example cover 202 of the example electronic device 200. In some examples, the cover 202 is used as the C-cover of a laptop. The electronic device 200 includes an example tactile keyboard 204. The keyboard 204 is supported by an example support plate 206, which is the feature visible in FIG. 2. The keys of the keyboard 204 are on the other side of the electronic device 200 from the view of FIG. 2. In FIG. 2, the tactile keyboard 204 is partially assembled as the first or top row of keys are not assembled. The cover 202 includes an example plurality of apertures 208 for receipt of the keys for the top row of the tactile keyboard 204.

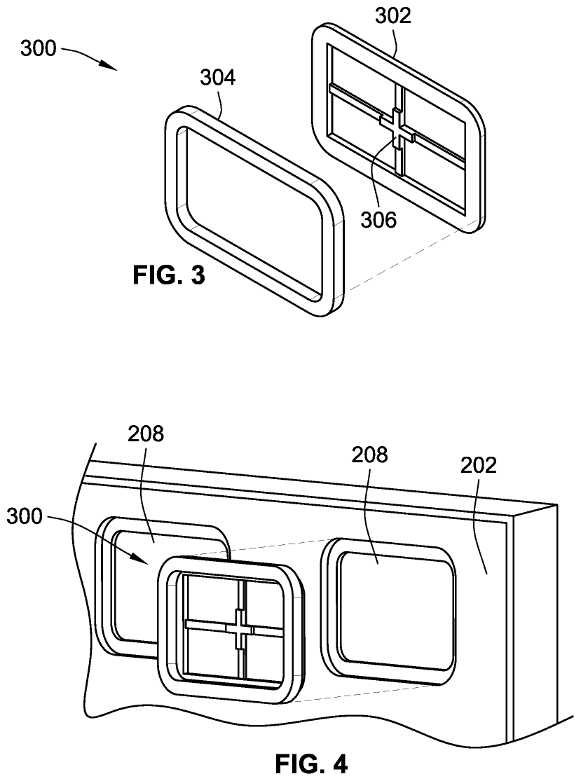

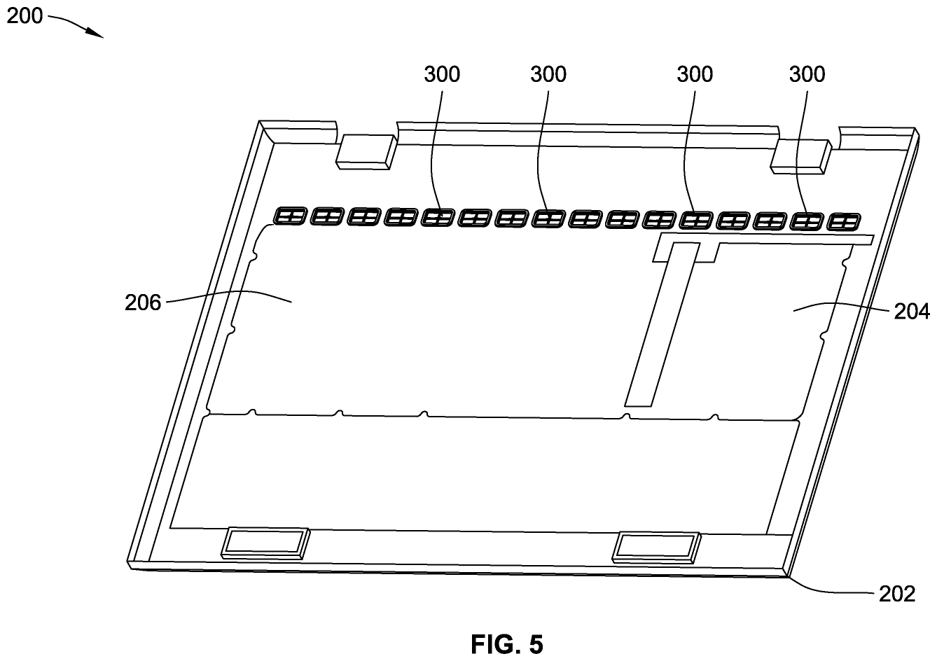

FIG. 3 illustrates an exploded view of an example key 300 for the tactile keyboard 204 of FIG. 2. The key 300 includes an example key cap 302 and an example gasket 304. In some examples, the gasket 304 includes a sponge. The key cap 302 includes a protrusion 306 that extends from the surface of the key cap 302. In the illustrated example, the protrusion 306 is a rib or cross shaped feature. To assemble the key 300, the gasket 304 is coupled (e.g., adhered) to the key cap 302. In some examples, the keys 300 are individually assembled onto the cover 202 into the apertures 208 as shown in FIG. 4. In some examples, the top row of keys 300 are coupled in a strip (e.g., of plastic and/or rubber) and assembled into corresponding apertures 208 as a group. Also, in some examples, the keys 300 of the other row of keys (i.e., the second row of keys 300, third row of keys 300, etc. of the tactile keyboard 204 may be assembled to the keyboard support plate 206 and coupled to the cover 202 together. FIG. 5 illustrates the cover 202 with the tactile keyboard 204 including the top row of keys 300 fully assembled to the cover 202.

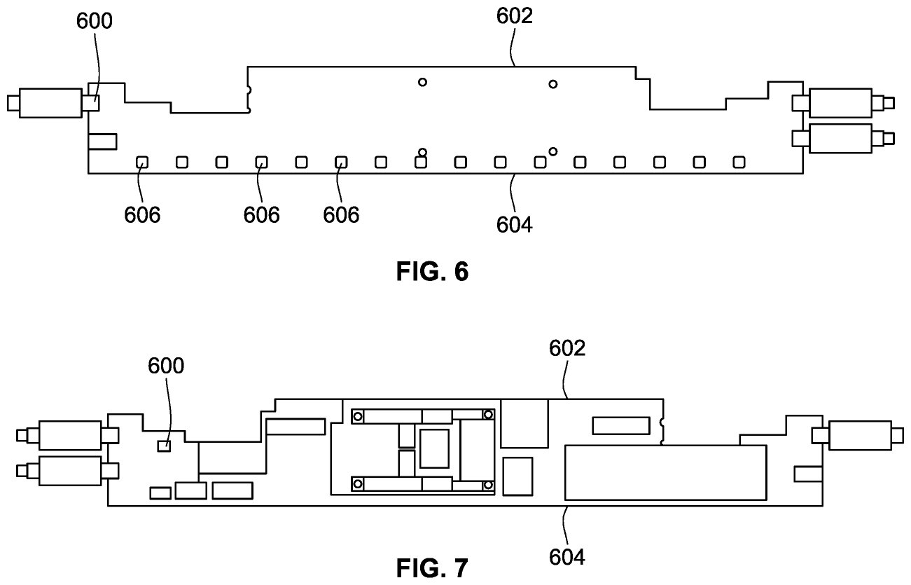

FIG. 6 illustrates a top view of an example printed circuit board 600. FIG. 7 illustrates a bottom view of the printed circuit board 600 of FIG. 6. The top side of the printed circuit board 600 faces upward toward the user when the electronic device 200 is in use. The printed circuit board 600 has a first end 602 and a second end 604. The second end 604 is opposite the first end 602. The keys 300 for the top row of keys 300 of the keyboard 204 are positioned on or above the printed circuit board 600 when the printed circuit board 600 is assemble to the cover 202. The printed circuit board 600 includes a plurality of switches 606. In the illustrated example, the switches 606 are physical switches. In some examples, the switches 606 are tact switches. In some examples, the switches 606 are soldered to the printed circuit board 600. The keys 300 of the top row of the tactile keyboard 204 align with respective switches 606 when the printed circuit board 600 is assembled to the cover 202. The keys 300 interact with the respective switches 606. For example, pressing a key 300 in the top row triggers the corresponding switch 606.

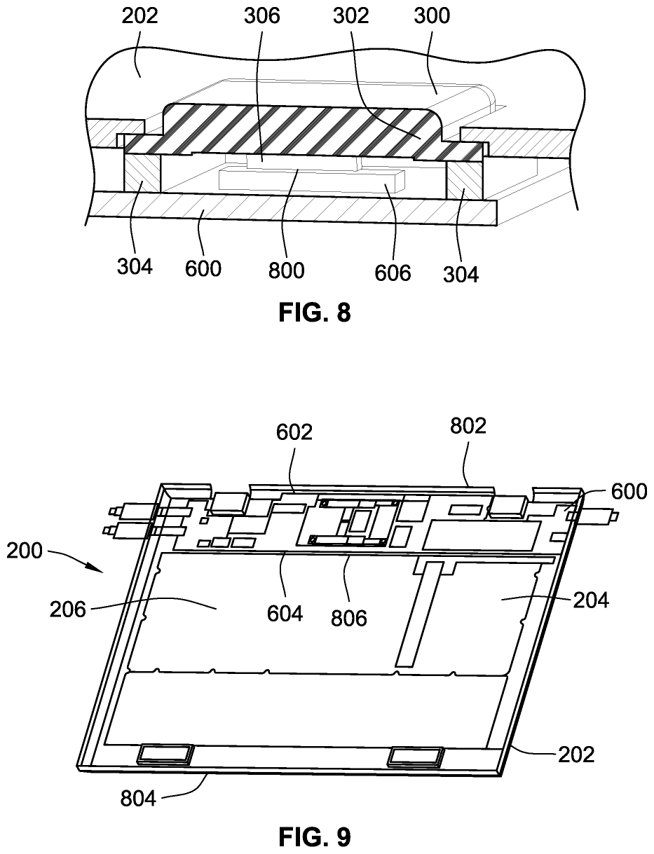

FIG. 8 is an enlarged cross-sectional view of an example key and switch connection. The illustrated example includes low-stroke switches. In the illustrated example, the gasket 304 surrounds the switch 606 and supports the key cap 302 above the switch 606 on the printed circuit board 600. There is a gap 800 between the key cap 302 and the switch 606. In some examples, the gap 800 is about 0.2 mm. In other examples, the gap 900 has a greater or smaller height. When the key 300 is pressed, the gasket 304 compresses into the printed circuit board 600. The key cap 302 travels the distance of the gap 900 and the protrusion 306 connects with the switch 606. In the example of a tact switch, the key cap 302 contacts a metal dome of the switch 606. The dome of the switch 606 collapses or bends a distance (e.g., approximately 0.2 mm). The collapsed or bent dome closes the circuit coupled to the switch 606, which signifies that the key 300 has been pressed. Upon release of the key 300, the switch 606 and the gasket 304 expand back to the position shown in FIG. 8.

FIG. 9 illustrates the cover 202 with the printed circuit board 600 coupled thereto. The cover 202 has a perimeter including a first edge 802 and a second edge 804. The first edge 802 is near a top of the cover 202 in this illustration. The first edge 802 is the edge near where, for a laptop device, a hinge is located to couple to a display panel. In this example, the area adjacent the first edge 802 forms the forehead. The printed circuit board 600 is coupled to the cover 202 near the first edge 802. In the illustrated example, the first end 602 of the printed circuit board 600 is adjacent the first edge 802 of the cover 202. The second end 604 of the printed circuit board 600 is coupled toward the interior of the electronic device 200 near an end 806 of the keyboard support plate 206.

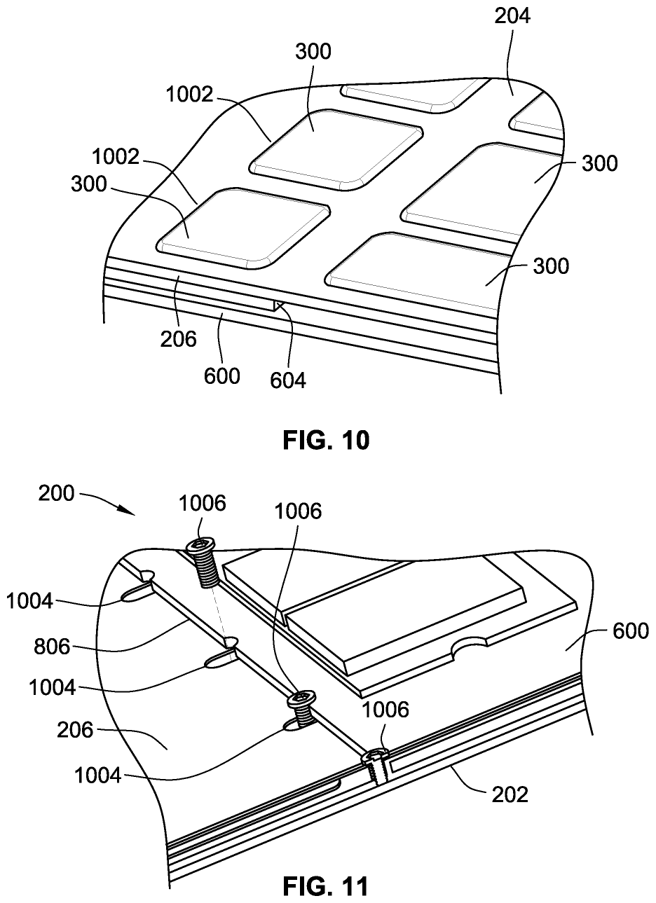

FIG. 10 is an enlarged top perspective view of a partial cross-sectional of the tactile keyboard 204 and the printed circuit board 600. FIG. 11 is an enlarged bottom perspective view of a partial cross-sectional of the tactile keyboard of and the printed circuit board 600. The first rows of keys 300 are coupled to the cover 202 above the printed circuit board 600 at the second end 604 of the printed circuit board 600. In some examples the cover 202 may include example bosses 1002 that surround the apertures 208 to support the keys 300.

The keyboard support plate 206 includes a plurality of example receptacles 1004 to receive a respective example fastener 1006 to couple the printed circuit board 600 to the keyboard support plate 206. The fasteners 1006 can include, for example, screws, rivets, bolts, and/or other suitable fastening mechanisms. In some examples, the fasteners 1006 extend along a length of the printed circuit board 600 and/or keyboard support plate 206. In some examples, the second end 604 of the printed circuit board 600 is aligned along the keyboard support plate 206 between the first or top row of the plurality of rows of keys 300 and the second row of the plurality of rows of keys 300 of the tactile keyboard 204.

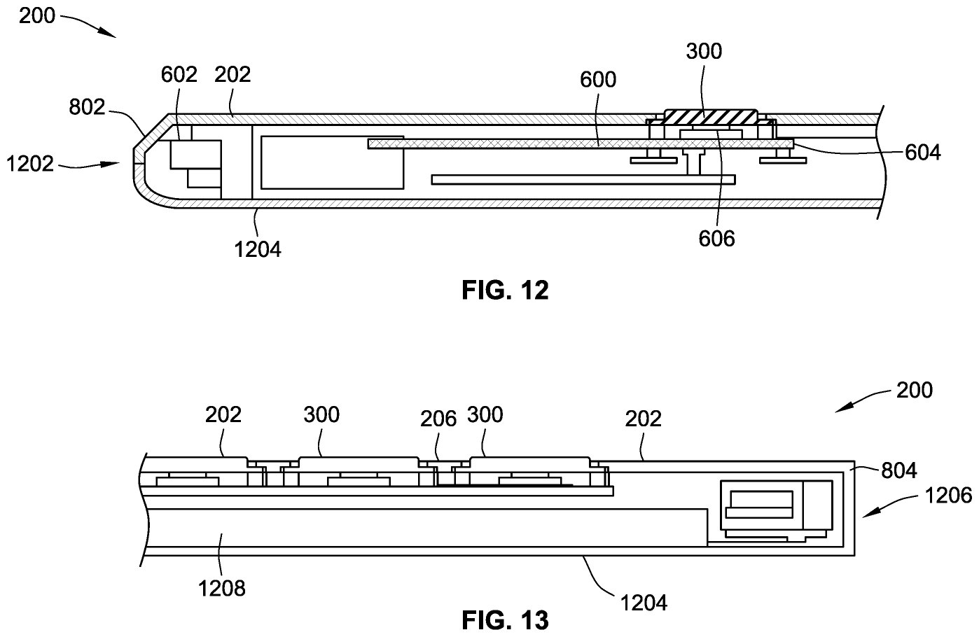

FIG. 12 is a cross-sectional view of a portion of a first end 1202 the electronic device incorporating the cover 202, the tactile keyboard 204, and the printed circuit board 600. The electronic device 200 includes a back cover 1204. The cover 202 and the back cover 204 form a base panel of the electronic device 200. In an example in which the electronic device 200 is a laptop or portable computer, the base panel is rotatably coupled to a display panel. The keys 300 in the first row of keys of the tactile keyboard 204 protrude from the cover 202. The keys 300 in the first row of keys of the tactile keyboard 204 are aligned above the switches 606 and the printed circuit board 600 at the second end 604 of the printed circuit board 600.

FIG. 13 is a cross-sectional view of a portion of a second end 1206 the electronic device 200 incorporating the cover 202, the tactile keyboard 204, and the printed circuit board 600. The printed circuit board 600 is not positioned in the portion of the electronic device 200 shown in FIG. 13. The keys 300 in the second row of keys, third row of keys, etc. of the tactile keyboard 204 protrude from the cover 202. In some examples, the keys 300 in the second row of keys, third row of keys, etc. of the tactile keyboard 204 may include scissor-leg key structures. In some examples, the keys 300 in the second row of keys, third row of keys, etc. of the tactile keyboard 204 also interact with switches such as, for example, tact switches. The keys 300 in the first row of keys of the tactile keyboard 204 are aligned above a component 1208 of the electronic device 200 that is adjacent to the printed circuit board 600. In some examples, the component 1208 is a battery. The examples with the tactile keyboard 204 partially disposed over the printed circuit board 600 enable a reduction in the z-height of the system. In some examples, the electronic device 200 has a thickness (z-height) of about 6.85 mm, which is less than 10.1 mm thickness of conventional designs (e.g. FIG. 1).

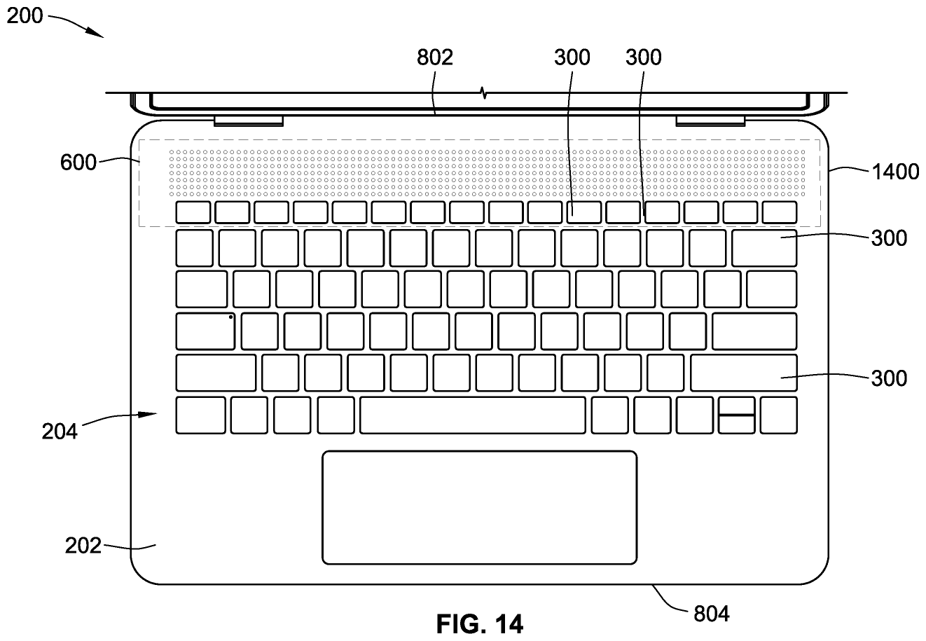

FIG. 14 illustrates a top view of a portion of the cover 202 of the electronic device 200 incorporating the tactile keyboard 204 and printed circuit board 600. In this example, a forehead 1400 of the cover 2002 near the first edge 802 is thinner or narrower than prior designs (compare FIG. 1). For example, the forehead 1400 may have a depth (in the y-dimension) of about 38.5 mm. For reference, a touch pad 1402 is closer to the second edge 804.

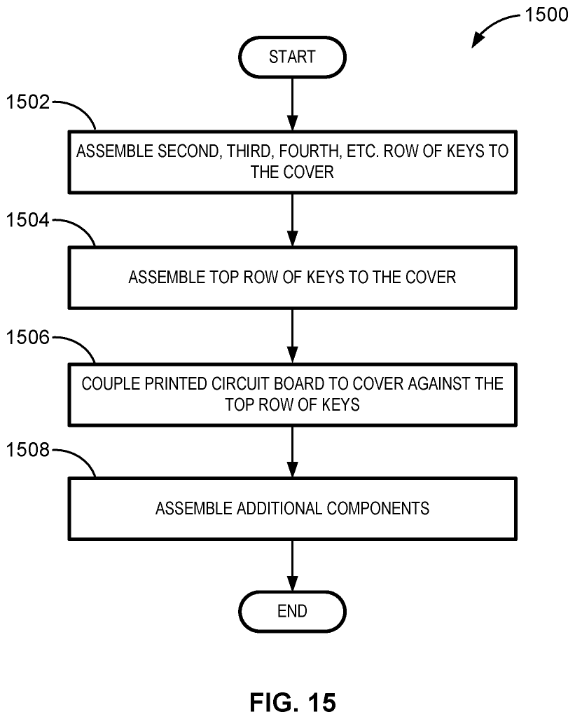

FIG. 15 is a flowchart representing instructions or process 1500 to assemble an electronic device 200 in accordance with the teaching of this disclosure. Other processes for assembling the electronic device 200 may also be used. For example, the order of execution of the blocks of the flowchart(s) may be changed, and/or some of the blocks described may be changed, eliminated, or combined.

The example process 1500 includes the assembly of the second, third, fourth, etc. rows of keys 300 of the keyboard 204 are assembled to the cover (e.g., a C-cover) of the electronic device 200 (block 1502). In a five row keyboard, rows two through five are assembled in block 1502. In a six row keyboard, rows two through six are assembled in block 1502. In some examples, the second, third, fourth etc. rows of keys 300 are assembled to the cover 202 collectively.

An additional row of key 300, i.e., the top row of keys 300 are assembled to the cover 202 (block 1504). In some examples, the keys 300 of the first row of keys are inserted into the apertures 208 of the cover 202 individually. In some examples, the keys 300 of the top row of keys are assembled to the cover 202 collectively.

The printed circuit board 600 is coupled to the cover 202 against the top row of keys (block 1506). For example, the top row of keys 300 are positioned between the cover 202 and the printed circuit board 600. Additional components of the electronic device 200 are assembled (block 1508) to complete the electronic device 200.

Examples disclosed herein allow for the electronic device 200 to have a reduced z-height. In addition, the placement of the printed circuit board 600 near the first edge 802 of the cover 202 and the partial overlay of the tactile keyboard 204 (via the top row of keys 300) allow for the electronic device 200 to have a thin and narrow forehead. In some examples, the use of a five-row keyboard (for rows two through six of the tactile keyboard 204) mixed with the separate top row of keys 300 weighs less than conventional designs with a single, integrated keyboard. In addition, the use of the separate, individual top row keys 300 is beneficial from a sustainability point of view because full keyboard replacement is avoided if a defect or failure occurs only at the top row keys 300.

Examples disclosed herein also enable these smaller form factors for the electronic device 200 while avoiding the use of touch sensors. Touch sensors are less reliable and robust than physical keyboards. Touch sensors have shorter life spans and cost more to repair than physical keyboards. In addition, touch sensors provide an inferior user experience than physical keyboards.

Examples disclosed herein use the term “top” or “first” for the row of keys that appear at the top of a keyboard. However, the examples disclosed herein for overlaying this row of keys with the printed circuit board equally apply to other configurations including, for example, the bottom or last row of keys, the left-most row, the right-most row, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

Systems, apparatus, articles of manufacture, and methods are disclosed for electronic devices with tactile keyboards. Example 1 includes an electronic device including: a tactile keyboard having a plurality of rows of keys; a printed circuit board; a first row of switches on the printed circuit board, a first row of the plurality of rows of keys to interact with the first row of switches; and a second row of switches on a component adjacent to the printed circuit board, a second row of the plurality of rows of keys to interact with the second row of switches.

Example 2 includes the electronic device of Example 1, wherein the first row of switches include tact switches.

Example 3 includes the electronic device of any of Examples 1 or 2, wherein the first row of the plurality of rows of keys comprises at least one key having a key cap and a sponge coupled to the key cap.

Example 4 includes the electronic device of any of Examples 1-3, further including: a first edge; a second edge opposite the first edge, wherein the printed circuit board is closer to the first edge than to the second edge; and a touch pad closer to the second edge than to the first edge.

Example 5 includes the electronic device of Example 4, wherein the first row of the plurality of rows of keys is disposed within about 40 millimeters from the first edge.

Example 6 includes the electronic device of any of Examples 4 or 5, wherein the printed circuit board comprises a first end adjacent the first edge and a second end, and wherein the first row of switches is at the second end.

Example 7 includes the electronic device of any of Examples 1-6, further including: a first cover, the tactile keyboard protruding from the first cover; and a second cover opposite the first cover, the printed circuit board and the component being between the first cover and the second cover, the first row of switches being between the printed circuit board and the first cover, and the second row of switches being between the component and the first cover.

Example 8 includes the electronic device of any of Examples 1-7, wherein the component includes a battery.

Example 9 includes the electronic device of any of Examples 1-8, wherein the tactile keyboard includes a keyboard support plate to support the plurality of rows of keys, the printed circuit board coupled to keyboard support plate.

Example 10 includes the electronic device of Example 9, wherein the printed circuit board is coupled to the keyboard support plate between the first row of the plurality of rows of keys and the second row of the plurality of rows of keys.

Example 11 includes the electronic device of Example 10, wherein the keyboard support plate includes a receptacle to receive a fastener to couple the printed circuit board to the keyboard support plate.

Example 12 includes the electronic device of any of Examples 10 or 11, wherein an end of the printed circuit board is aligned along the keyboard support plate between the first row of the plurality of rows of keys and the second row of the plurality of rows of keys.

Example 13 includes a portable computer comprising: a display panel; and a base panel, the display panel rotatably coupled to the base panel, the base panel including: a tactile keyboard having a plurality of rows of keys; a printed circuit board having a first end near a perimeter of the base panel and a second end opposite the first end; and a row of physical switches at the second end of the printed circuit board, a top row of the plurality of rows of keys to interact with the row of physical switches.

Example 14 includes the portable computer of Example 13, wherein the row of physical switches is a first row of physical switches, the base panel including a second row of physical switches supported on a component adjacent to the printed circuit board, a second row of the plurality of rows of keys to interact with the second row of physical switches.

Example 15 includes the portable computer of any of Examples 13 or 14, wherein the base panel includes a keyboard support plate to support the tactile keyboard, the printed circuit board coupled to the keyboard support plate between the first row of the plurality of rows of keys and the second row of the plurality of rows of keys.

Example 16 includes the portable computer of Example 15, further including a fastener to couple the second end of the printed circuit board to an end of the keyboard support plate.

Example 17 includes the portable computer of any of Examples 15 or 16, further including a plurality of fasteners along a length of the second end of the printed circuit board and a length of an end of the keyboard support plate to couple the second end of the printed circuit board with the end of the keyboard support plate.

Example 18 includes a method of assembling an electronic device, the method including: assembling a plurality of rows of keys of a keyboard on a cover; assembling an additional row of keys on the cover between the plurality of rows of keys and an edge of the cover, the additional row of keys to form a top row of keys above the plurality of rows of keys; and coupling a printed circuit board to the cover between the edge of the cover and the plurality of rows of keys, wherein the additional row of keys are positioned between the printed circuit and the cover, and wherein the printed circuit includes physical switches aligned with the additional row of keys when the printed circuit board is coupled to the cover.

Example 19 includes the method of Example 18, wherein the cover includes apertures, and assembling the additional row of keys includes inserting key caps through the apertures.

Example 20 includes the method of any of Examples 18 or 19, wherein the plurality of rows of keys are supported by a keyboard support plate, and coupling the printed circuit board includes fastening an end of the printed circuit to an end of the keyboard support plate.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An electronic device comprising:
a tactile keyboard having a plurality of rows of keys;
a printed circuit board;
a first row of switches on the printed circuit board, a first row of the plurality of rows of keys to interact with the first row of switches; and
a second row of switches on a component adjacent to the printed circuit board, a second row of the plurality of rows of keys to interact with the second row of switches.

2. The electronic device of claim 1, wherein the first row of switches include tact switches.

3. The electronic device of claim 1, wherein the first row of the plurality of rows of keys comprises at least one key having a key cap and a sponge coupled to the key cap.

4. The electronic device of claim 1, further including:
a first edge;
a second edge opposite the first edge, wherein the printed circuit board is closer to the first edge than to the second edge; and
a touch pad closer to the second edge than to the first edge.

5. The electronic device of claim 4, wherein the first row of the plurality of rows of keys is disposed within about 40 millimeters from the first edge.

6. The electronic device of claim 4, wherein the printed circuit board comprises a first end adjacent the first edge and a second end, and wherein the first row of switches is at the second end.

7. The electronic device of claim 1, further including:
a first cover, the tactile keyboard protruding from the first cover; and
a second cover opposite the first cover, the printed circuit board and the component being between the first cover and the second cover,
the first row of switches being between the printed circuit board and the first cover, and
the second row of switches being between the component and the first cover.

8. The electronic device of claim 1, wherein the component includes a battery.

9. The electronic device of claim 1, wherein the tactile keyboard includes a keyboard support plate to support the plurality of rows of keys, the printed circuit board coupled to keyboard support plate.

10. The electronic device of claim 9, wherein the printed circuit board is coupled to the keyboard support plate between the first row of the plurality of rows of keys and the second row of the plurality of rows of keys.

11. The electronic device of claim 10, wherein the keyboard support plate includes a receptacle to receive a fastener to couple the printed circuit board to the keyboard support plate.

12. The electronic device of claim 10, wherein an end of the printed circuit board is aligned along the keyboard support plate between the first row of the plurality of rows of keys and the second row of the plurality of rows of keys.

13. A portable computer comprising:
a display panel; and
a base panel, the display panel rotatably coupled to the base panel, the base panel including:
a tactile keyboard having a plurality of rows of keys;
a printed circuit board having a first end near a perimeter of the base panel and a second end opposite the first end; and
a row of physical switches at the second end of the printed circuit board, a top row of the plurality of rows of keys to interact with the row of physical switches.

14. The portable computer of claim 13, wherein the row of physical switches is a first row of physical switches, the base panel including a second row of physical switches supported on a component adjacent to the printed circuit board, a second row of the plurality of rows of keys to interact with the second row of physical switches.

15. The portable computer of claim 13, wherein the base panel includes a keyboard support plate to support the tactile keyboard, the printed circuit board coupled to the keyboard support plate between the first row of the plurality of rows of keys and the second row of the plurality of rows of keys.

16. The portable computer of claim 15, further including a fastener to couple the second end of the printed circuit board to an end of the keyboard support plate.

17. The portable computer of claim 15, further including a plurality of fasteners along a length of the second end of the printed circuit board and a length of an end of the keyboard support plate to couple the second end of the printed circuit board with the end of the keyboard support plate.

18. A method of assembling an electronic device, the method including:
assembling a plurality of rows of keys of a keyboard on a cover;
assembling an additional row of keys on the cover between the plurality of rows of keys and an edge of the cover, the additional row of keys to form a top row of keys above the plurality of rows of keys; and
coupling a printed circuit board to the cover between the edge of the cover and the plurality of rows of keys, wherein the additional row of keys are positioned between the printed circuit and the cover, and wherein the printed circuit includes physical switches aligned with the additional row of keys when the printed circuit board is coupled to the cover.

19. The method of claim 18, wherein the cover includes apertures, and assembling the additional row of keys includes inserting key caps through the apertures.

20. The method of claim 18, wherein the plurality of rows of keys are supported by a keyboard support plate, and coupling the printed circuit board includes fastening an end of the printed circuit to an end of the keyboard support plate.
